(19) United States
(12) Patent Application Publication
(10) Pub. No.: US 2025/0231590 A1
(43) Pub. Date: Jul. 17, 2025

(54) CASE INCLUDING STRUCTURE FOR SUPPORTING ELECTRONIC DEVICE

(71) Applicant: SAMSUNG ELECTRONICS CO., LTD., Suwon-si (KR)

(72) Inventor: Jinkyu JEONG, Suwon-si (KR)

(21) Appl. No.: 19/097,860

(22) Filed: Apr. 2, 2025

Related U.S. Application Data
(63) Continuation of application No. PCT/KR2023/013539, filed on Sep. 8, 2023.

(30) Foreign Application Priority Data
Oct. 14, 2022 (KR) 10-2022-0132399
Nov. 3, 2022 (KR) 10-2022-0145023

(51) Int. Cl. G06F 1/16

(52) U.S. Cl. CPC G06F 1/166; G06F 1/1629

(57) ABSTRACT

A case includes: a first base coupled to a portion of an electronic device; a second base including a first surface and a second surface opposite the first surface; a first support part which is rotatably coupled to the second base, and movable parallel to the second surface by rotating in a first rotation direction, or movable to be inclined with respect to the second surface by rotating in a second rotation direction opposite the first rotation direction; and a second support part which is coupled to the second base to be rotatable independently of the first support part, and movable parallel to the second surface by rotating in the second rotation direction, or movable to support the side surface of the electronic device disposed on the first surface by rotating in the first rotation direction.

### CROSS-REFERENCE TO RELATED APPLICATION(S)

This application is a continuation application, claiming priority under 35 U.S.C. § 365 (c), of an International application No. PCT/KR2023/013539, filed on Sep. 8, 2023, which is based on and claims the benefit of a Korean patent application numbers 10-2022-0132399, filed on Oct. 14, 2022, and 10-2022-0145023, filed on Nov. 3, 2022, in the Korean Intellectual Property Office, the disclosure of which is incorporated by reference herein in its entirety.

### BACKGROUND

### (1) Field

The present disclosure relates to a case including a structure for supporting an electronic device.

### (2) Description of the Related Art

When an electronic device is carried by a user, the electronic device may be exposed to various environments. A case, which is detachably coupled to the electronic device, may be provided to protect the electronic device exposed to various environments. For example, the case may protect the electronic device from an impact transmitted to the electronic device from the outside of the electronic device. In order to meet a demand of the user, the case may have various other functions in addition to a function for protecting the electronic device.

### SUMMARY

A case detachably coupled to an electronic device according to an embodiment includes a first base coupled to a portion of the electronic device. According to an embodiment, the case further includes a second base coupled to the first base to be rotatable relative to the first base, where the second base includes a first surface facing another portion of the electronic device and a second surface opposite to the first surface. According to an embodiment, the case further comprises a first support, rotatably coupled to the second base, and movable to be parallel to the second surface by rotation in a first rotation direction or movable to be inclined with respect to the second surface by rotation in a second rotation direction opposite to the first rotation direction. According to an embodiment, the case further includes a second support coupled to the second base to be rotatable independently of the first support, and movable to be parallel to the second surface by rotation in the second rotation direction, or movable to support a side surface of the electronic device disposed on the first surface by rotation in the first rotation direction.

A case detachably coupled to an electronic device according to an embodiment includes a first base coupled to a portion of the electronic device. According to an embodiment, the case further includes a second base coupled to the first base to be rotatable relative to the first base, where the second base includes a first surface facing another portion of the electronic device and a second surface opposite to the first surface, and a through-hole is defined through the second base to extend from the first surface to the second surface, and. According to an embodiment, the case further includes a first support rotatably coupled to the second base, and movable to be parallel to the second surface by rotation in a first rotation direction or movable to be inclined with respect to the second surface by rotation in a second rotation direction opposite to the first rotation direction. According to an embodiment, the case further includes a second support coupled to the second base to be rotatable independently of the first support, and movable to be received within the through-hole by rotation in the second rotation direction or movable to support a side surface of the electronic device disposed outside the through-hole by rotation in the first rotation direction.

### BRIEF DESCRIPTION OF THE DRAWINGS

FIG. 1A illustrates a case according to an embodiment in a state where the case is coupled with an electronic device in an unfolded state.

FIG. 1B illustrates a case according to an embodiment in a state where the case coupled with an electronic device in a folded state.

FIG. 2A is a top plan view of a case according to an embodiment.

FIG. 2B is a perspective view of a case according to an embodiment.

FIG. 2C is a side view of a case according to an embodiment.

FIG. 3A illustrates a first support according to an embodiment in a first position.

FIG. 3B illustrates a first support according to an embodiment in a second position.

FIG. 4A illustrates a second support according to an embodiment in a third position.

FIG. 4B illustrates a second support according to an embodiment in a fourth position.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

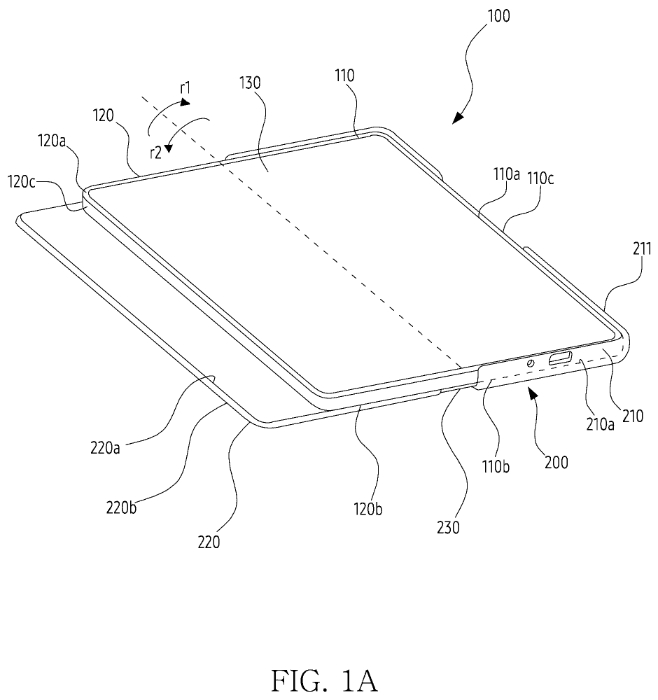

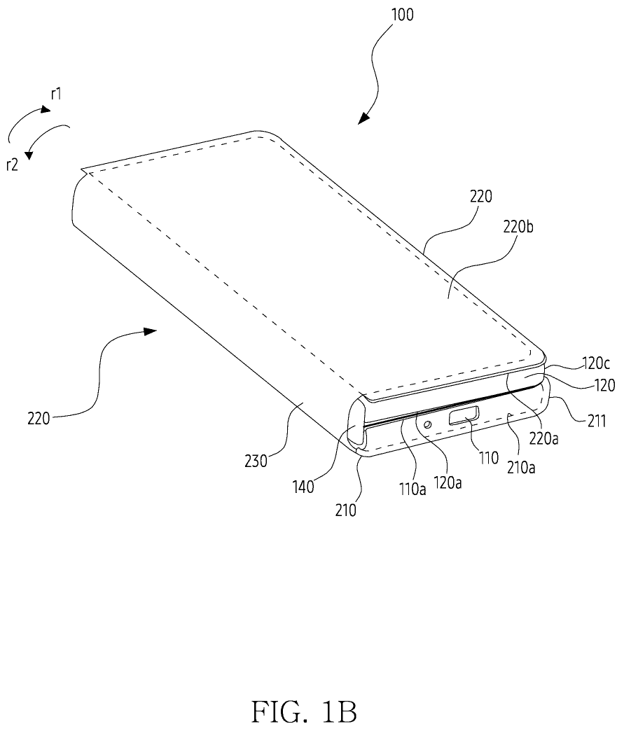

FIG. 1A illustrates a case according to an embodiment in a state where the case coupled with an electronic device in an unfolded state, and FIG. 1B illustrates a case according to an embodiment in a state where the case coupled with an electronic device in a folded state.

Referring to FIG. 1A and FIG. 1B, an electronic device 100 according to an embodiment may include a first housing 110, a second housing 120, a display 130, and/or a hinge structure 140.

The first housing 110 may define a portion of an outer surface of the electronic

device 100. The first housing 110 may provide or define a space in which a portion of components of the electronic device 100 may be disposed. The first housing 110 may support the portion of the components of the electronic device 100. For example, a first front surface 110a of the first housing 110 may support a portion of the display 130. A first rear surface 110b of the first housing 110 may be opposite to the first front surface 110a. For example, a direction in which the first rear surface 110b faces may be opposite to a direction in which the first front surface 110a faces. The first rear surface 110b may be spaced apart from the first front surface 110a. A first side surface 110c of the first housing 110 may be connected between the first front surface 110a and the first rear surface 110b. For example, the first side surface 110c may extend from the first front surface 110a to the first rear surface 110b. According to an embodiment, the first side surface 110c may surround sides of the first front surface 110a and sides of the first rear surface 110b. For example, the first side surface 110c may surround a periphery (or edge portions) of the first front surface 110a and a periphery (or edge portions) of the first rear surface 110b. According to an embodiment, the first side surface 110c may be perpendicular to the first front surface 110a and/or the first rear surface 110b, but is not limited thereto. For example, the first side surface 110c may be a curved surface which is bent with a curvature between the first front surface 110a and the first rear surface 110b.

The second housing 120 may define another portion of the outer surface of the electronic device 100. The second housing 120 may provide or define a space in which another portion of the components of the electronic device 100 may be disposed. The second housing 120 may support the other portion of the components of the electronic device 100. For example, a second front surface 120a of the second housing 120 may support another portion of the display 130. A second rear surface 120b of the second housing 120 may be opposite to the second front surface 120a. For example, a direction in which the second rear surface 120b faces may be opposite to a direction in which the second front surface 120a faces. The second rear surface 120b may be spaced apart from the second front surface 120a. A second side surface 120c of the second housing 120 may be connected between the second front surface 120a and the second rear surface 120b. For example, the second side surface 120c may extend from the second front surface 120a to the second rear surface 120b. According to an embodiment, the second side surface 120c may surround sides of the second front surface 120a and sides of the second rear surface 120b. For example, the second side surface 120c may surround a periphery (or edge portions) of the second front surface 120a and a periphery (or edge portions) of the second rear surface 120b. According to an embodiment, the second side surface 120c may be perpendicular to the second front surface 120a and/or the second rear surface 120b, but is not limited thereto. For example, the second side surface 120c may be a curved surface which is bent with a curvature between the second front surface 120a and the second rear surface 120b.

According to an embodiment, the second housing 120 may be movable with respect to the first housing 110. For example, the second housing 120 may be coupled to the first housing 110 to be rotatable with respect to the first housing 110. For example, the second housing 120 may be rotatably coupled with respect to the first housing 110 through the hinge structure 140.

The display 130 may be configured to provide visual information or to display an image. For example, the display 130 may emit light to provide the visual information along the direction in which the first front surface 110a faces and the direction in which the second front surface 120a faces. According to an embodiment, the display 130 may be coupled to the first housing 110 and the second housing 120. For example, the display 130 may be disposed on the first front surface 110a of the first housing 110 and the second front surface 120a of the second housing 120. The display 130 may extend from the first housing 110 to the second housing 120 across the hinge structure 140. The display 130 may be deformable by a movement of the second housing 120 with respect to the first housing 110. For example, the display 130 may be foldable by the movement of the second housing 120 with respect to the first housing 110.

The hinge structure 140 may rotatably couple the first housing 110 and the second housing 120 to each other. For example, the first housing 110 may be rotatable with respect to the second housing 120 through the hinge structure 140. For example, the second housing 120 may be rotatable with respect to the first housing 110 through the hinge structure 140. According to an embodiment, a state of the electronic device 100 may be changed by the movement of the second housing 120 with respect to the first housing 110. The state of the electronic device 100 may include an unfolded state and/or a folded state. In the unfolded state of the electronic device 100 (i.e., when the electronic device 100 is in the unfolded state), the direction in which the first front surface 110a of the first housing 110 faces and the direction in which the second front surface 120a of the second housing 120 faces may be the same. In the unfolded state of the electronic device 100, the display 130 may be unfolded. In the unfolded state of the electronic device 100, a size of visually recognizable extent of the display 130 from the outside of the electronic device 100 may be a maximum. As the second housing 120 rotates with respect to the first housing 110, the state of the electronic device 100 may be changed from the unfolded state to the folded state. In the folded state of the electronic device 100 (i.e., when the electronic device 100 is in the folded state), the first front surface 110a of the first housing 110 and the second front surface 120a of the second housing 120 may face each other. In the folded state of the electronic device 100, the direction in which the first front surface 110a of the first housing 110 faces may be opposite to the direction in which the second front surface 120a of the second housing 120 faces. In the folded state of the electronic device 100, the display 130 may be folded. In the folded state of the electronic device 100, the size of the visually recognizable extent of the display 130 from the outside of the electronic device 100 may be a minimum.

In an embodiment, as described above, the state of the electronic device 100 may include the folded state and the unfolded state, but is not limited thereto. For example, the state of the electronic device 100 may include an intermediate state in which the direction in which the first front surface 110a of the first housing 110 faces is inclined with respect to the direction in which the second front surface 120a of the second housing 120 faces. For example, the intermediate state of the electronic device 100 may be referred to as a flex mode.

According to an embodiment, as the state of the electronic device 100 is changed, at least a portion of the hinge structure 140 may be visually recognizable from the outside. For example, in the unfolded state of the electronic device 100, the hinge structure 140 may be covered by the first housing 110 and the second housing 120. For example, in the unfolded state of the electronic device 100, the hinge structure 140 may be disposed inside the first housing 110 and the second housing 120. For example, in the unfolded state of the electronic device 100, the hinge structure 140 may not be visible from the outside of the electronic device 100. For example, in the folded state of the electronic device 100, the at least a portion of the hinge structure 140 may be exposed outside the first housing 110 and the second housing 120.

A case 200 may protect the electronic device 100. For example, the case 200 may protect the electronic device 100 by surrounding at least a portion of the outer surface of the electronic device 100. For example, the case 200 may reduce damage to the electronic device 100 due to an impact transmitted thereto from the outside. The case 200 may be detachably coupled to the electronic device 100. According to an embodiment, the case 200 may include a first base 210, a second base 220, and/or a connecting plate 230.

The first base 210 may protect a portion of the electronic device 100. The first base 210 may be coupled to the portion of the electronic device 100. For example, the first base 210 may be detachably coupled to the first housing 110. According to an embodiment, the first base 210 may have a shape corresponding to a shape of the portion of the electronic device 100. For example, the first base 210 may have a shape corresponding to an outer surface of the first housing 110. The first base 210 may surround the first side surface 110c of the first housing 110 by having the shape corresponding to the outer surface of the first housing 110. However, it is not limited thereto, and the first base 210 may be coupled to the portion of the electronic device 100 by various ways or methods. For example, the first base 210 may be coupled to the portion of the electronic device 100 through an adhesive material. For example, the first base 210 may be coupled to the portion of the electronic device 100 through a magnetic material.

The second base 220 may protect another portion of the electronic device 100. The second base 220 may be coupled to the other portion of the electronic device 100. For example, the second base 220 may be detachably coupled to the second housing 120. According to an embodiment, the second base 220 may include a first surface 220a and a second surface 220b. The first surface 220a may support the second housing 120. For example, the first surface 220a may support the second rear surface 120b of the second housing 120. The second surface 220b may be opposite to the first surface 220a. For example, a direction in which the second surface 220b faces may be opposite to a direction in which the first surface 220a faces. According to an embodiment, a size (or an area) of the first surface 220a and a size of the second surface 220b may be the same as each other. For example, the size of the first surface 220a may correspond to a size of the second rear surface 120b of the second housing 120. For example, the size of the second surface 220b may correspond to the size of the second rear surface 120b of the second housing 120. According to an embodiment, the second base 220 may be coupled to the other portion of the electronic device 100 by a magnetic material included in the second base 220, but is not limited thereto. For example, the second base 220 may be coupled to the other portion of the electronic device 100 by an adhesive material included in the second base 220.

According to an embodiment, the second base 220 may be coupled to the first base 210 to be movable with respect to the first base 210. The second base 220 may be coupled to the first base 210 to be rotatable with respect to the first base 210. According to an embodiment, a state of the case 200 may be changed by a movement of the second base 220 with respect to the first base 210. The state of the case 200 may include a first state and/or a second state.

Referring to FIG. 1A, in the first state of the case 200 (i.e., when the case 200 is in the first state), a direction in which a third surface 210a of the first base 210 that supports a portion of the electronic device 100 faces may correspond to a direction in which the first surface 220a of the second base 220 faces. For example, in the first state of the case 200, the direction in which the third surface 210a of the first base 210 that supports the portion of the electronic device 100 faces may be the same as the direction in which the first surface 220a of the second base 220 faces. In the first state of the case 200, the state of the electronic device 100 may be the unfolded state. In the first state of the case 200, a portion of the first surface 220a of the second base 220 may contact a portion of the second rear surface 120b of the second housing 120. In the first state of the case 200, another portion of the first surface 220a of the second base 220 may be exposed outside the case 200. According to an embodiment, the state of the case 200 may be changeable from the first state in which the direction in which the first surface 220a faces and the direction in which the third surface 210a faces are the same as each other, by rotation in a first rotation direction r1 of the second base 220, to the second state in which the first surface 220a and the third surface 210a face each other.

Referring to FIG. 1B, in the second state of the case 200 (i.e., when the case 200 is in the second state), the third surface 210a of the first base 210 and the first surface 220a of the second base 220 may face each other. For example, in the second state of the case 200, the direction in which the third surface 210a of the first base 210 faces may be opposite to the direction in which the first surface 220a of the second base 220 faces. In the second state of the case 200, the state of the electronic device 100 may be the folded state. In the second state of the case 200, the first surface 220a of the second base 220 may contact the second rear surface 120b of the second housing 120. In the second state of the case 200, the first surface 220a of the second base 220 may be spaced apart from the hinge structure 140. According to an embodiment, the state of the case 200 may be changeable from the second state in which the first surface 220a and the third surface 210a face each other, by rotation in a second rotation direction r2 of the second base 220, to the first state in which the direction in which the first surface 220a faces and the direction in which the third surface 210a faces are the same. The second rotation direction r2 may be opposite to the first rotation direction r1.

The connecting plate 230 may be disposed between the first base 210 and the second base 220. The connecting plate 230 may be connected the first base 210 and the second base 220. For example, the connecting plate 230 may extend from the first base 210 to the second base 220. For example, the connecting plate 230 may rotatably couple the second base 220 to the first base 210. According to an embodiment, in the first state of the case 200, the connecting plate 230 may contact another portion of the second rear surface 120b of the second housing 120. In the second state of the case 200, the connecting plate 230 may surround the hinge structure 140.

According to an embodiment, the first base 210 may include a sidewall 211. The sidewall 211 may surround a portion of the electronic device 100 in a state in which the case 200 and the electronic device 100 are coupled to each other. In the state in which the case 200 and the electronic device 100 are coupled, the sidewall 211 may surround an area of the side surface of the electronic device 100. For example, in the state in which the case 200 and the electronic device 100 are coupled, the sidewall 211 may surround at least a portion of the first side surface 110c of the first housing 110. As the sidewall 211 surrounds the first housing 110, the case 200 may maintain the state in which the electronic device 100 is coupled thereto. According to an embodiment, the sidewall 211 may be connected to the third surface 210a. For example, the sidewall 211 may be disposed on a periphery of the third surface 210a to surround the at least a portion of the first side surface 110c. For example, the sidewall 211 may extend from the periphery of the third surface 210a along the direction in which the third surface 210a faces.

According to an embodiment, the second base 220 may have a substantially planar shape such that the portion of the electronic device 100 is exposed outside the case 200. For example, the second base 220 may have a shape extending in a direction parallel to the second surface 220b so that the second side surface 120c of the second housing 120 is exposed outside of the case 200. As the second base 220 has the substantially planar shape, the second base 220 may not surround the second side surface 120c in the state in which the case 200 and the electronic device 100 are coupled. For example, a size of extent of the outer surface (or an overall external surface area) of the electronic device 100 may be changed according to a change in the state of the electronic device 100. For example, as the state of the electronic device 100 changes from the unfolded state to the folded state, since the hinge structure 140 is exposed outside the electronic device 100, the size of the extent of the outer surface of the electronic device 100 may increase. In the case that the second base 220 surrounds the second side surface 120c of the second housing 120 in the unfolded state of the electronic device 100, since the size of the extent of the outer surface of the electronic device 100 increases as the state of the electronic device 100 changes from the unfolded state to the folded state, stress extending the connecting plate 230 may be generated. In the case that the second base 220 surrounds the second side surface 120c in the folded state of the electronic device 100, since the size of the extent of the outer surface of the electronic device 100 decreases as the state of the electronic device 100 changes from the folded state to the unfolded state, stress for compressing the connecting plate 230 may be generated. The case 200 according to an embodiment may provide a structure capable of reducing damage to the connecting plate 230 due to the stress generated according to the change in the state of the electronic device 100 by the second base 220 having the substantially planar shape.

The electronic device 100 may provide visual information through the display 130 in the state of being coupled with the case 200. The case 200 may support the electronic device 100 in an inclined state with respect to a ground or a supporting surface on which the electronic device 100 is mounted such that a user may conveniently view the visual information. Since the second base 220 has the planar shape, the case 200 may be desired to have a structure for supporting the second side surface 120c of the second housing 120 while supporting the electronic device 100 in the inclined state with respect to the ground or the supporting surface. Hereinafter, a structure of the case 200 for supporting the electronic device 100 in the inclined state will be described in detail.

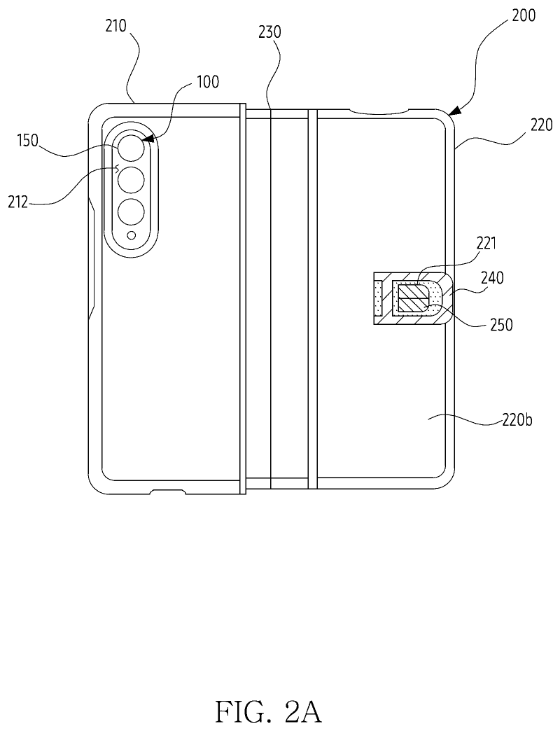

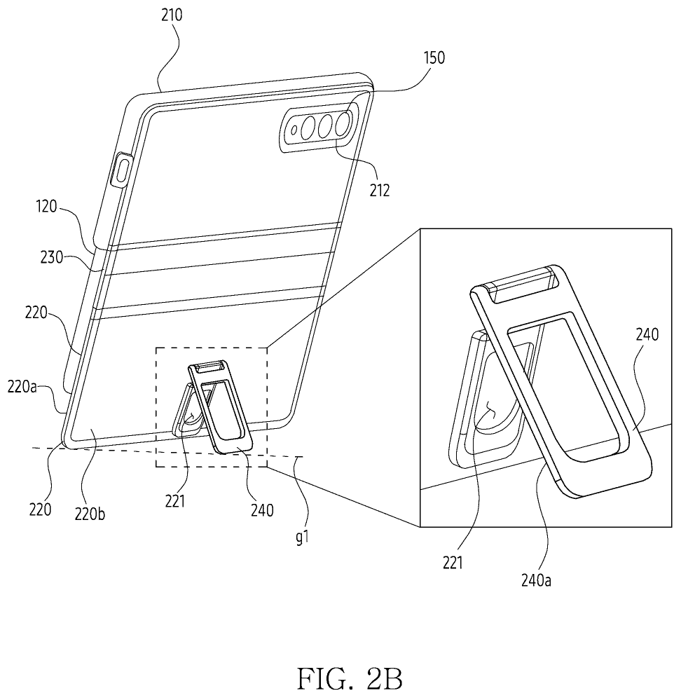

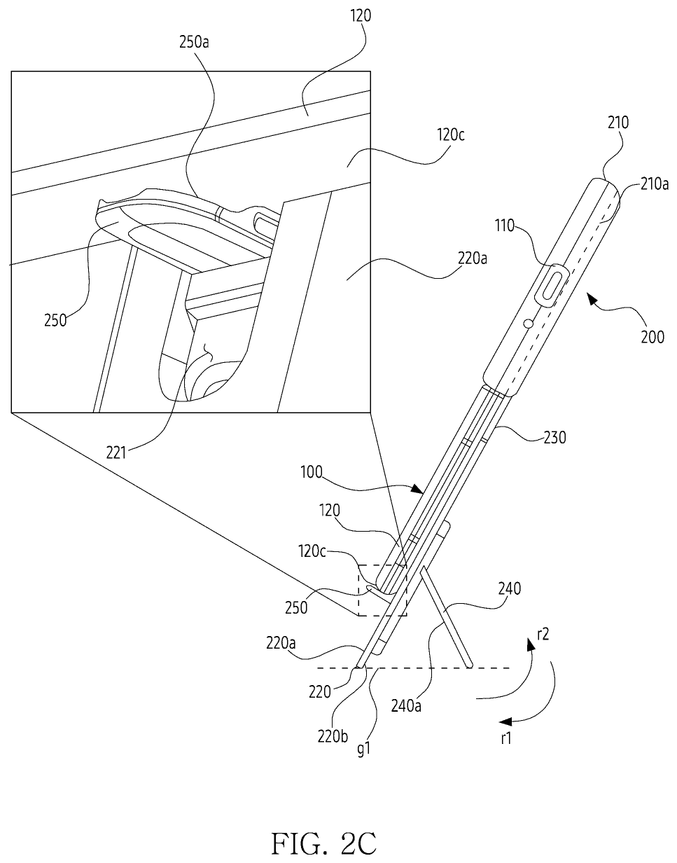

FIG. 2A is a top plan view of a case according to an embodiment, FIG. 2B is a perspective view of a case according to an embodiment, and FIG. 2C is a side view of a case according to an embodiment.

Referring to FIG. 2A, FIG. 2B, and FIG. 2C, a case 200 according to an embodiment may include a first support 240 and/or a second support 250.

According to an embodiment, a second base 220 may be provided with a through-hole 221, that is the through-hole 221 may be defined or formed through the second base 220. The through-hole 221 may receive the second support 250, that is the second support 250 may be disposed or inserted in the through-hole 221. The through-hole 221 may provide a space in which the second support 250 may move. According to an embodiment, the through-hole 221 may be defined or formed through the second base 220. For example, the through-hole 221 may extend from a first surface 220a toward a second surface 220b.

The first support 240 may be rotatably coupled to the second base 220. The first support 240 may be rotatable in a first rotation direction r1 and/or a second rotation direction r2 opposite to the first rotation direction r1. As the first support 240 rotates in the first rotation direction r1, the first support 240 may approach the second surface 220b of the second base 220. As the first support 240 rotates in the second rotation direction r2 opposite to the first rotation direction r1, the first support 240 may move away from the second surface 220b of the second base 220. For example, the first support 240 may be movable to be parallel to the second surface 220b by rotation in the first rotation direction r1. For example, the first support 240 may be movable to be inclined with respect to the second surface 220b by rotation in the second rotation direction r2.

According to an embodiment, a position of the first support 240 may include a first position parallel to the second surface 220b of the second base 220, and a second position inclined with respect to the second surface 220b of the second base 220. For example, the first support 240 may be movable to be parallel to the second surface 220b or inclined to the second surface 220b in a first state of the case 200 in which a direction in which the first surface 220a faces and a direction in which a third surface 210a faces are the same as each other. When the position of the first support 240 is the first position, the first support 240 may contact the second surface 220b of the second base 220. For example, when the position of the first support 240 is the first position, an inner surface 240a of the first support 240 may contact the second base 220. When the position of the first support 240 is the first position, the inner surface 240a of the first support 240 may face the second surface 220b of the second base 220. When the position of the first support 240 is the first position, a direction in which the inner surface 240a of the first support 240 faces may be opposite to a direction in which the second surface 220b faces. When the position of the first support 240 is the second position, the inner surface 240a of the first support 240 may be inclined with respect to the second surface 220b of the second base 220. For example, when the position of the first support 240 is the second position, the direction in which the inner surface 240a of the first support 240 faces may be inclined with respect to the direction in which the second surface 220b of the second base 220 faces. When the position of the first support 240 is the second position, the first support 240 may support the case 200 and an electronic device 100 in a state inclined with respect to the ground g1.

The second support 250 may be coupled to the second base 220 to be rotatable with respect to the second base 220. The second support 250 may be rotatable with respect to the second base 220 independently of the first support 240. The second support 250 may be rotatable in the first rotation direction r1 and/or the second rotation direction r2 opposite to the first rotation direction r1. As the second support 250 rotates in the first rotation direction r1, the second support 250 may move away from the second surface 220b. As the second support 250 rotates in the second rotation direction r2, the second support 250 may approach the second surface 220b. For example, the second support 250 may be movable to be parallel to the second surface 220b of the second base 220 by rotation in the second rotation direction r2. The second support 250 may be movable to support a second side surface 120c of a second housing 120 disposed on the first surface 220a by rotation in the first rotation direction r1 opposite to the second rotation direction r2.

According to an embodiment, a position of the second support 250 may include a third position parallel with respect to the second surface 220b, and a fourth position that supports the second side surface 120c of the second housing 120 disposed on the first surface 220a. For example, in the first state of the case 200 in which the direction in which the first surface 220a faces and the direction of the third surface 210a faces are the same as each other, the second support 250 may be movable to be parallel to the second surface 220b or movable to support the second side surface 120c. When the position of the second support 250 is the third position, an inner surface 250a of the second support 250 may be parallel to the second surface 220b. When the position of the second support 250 is the third position, the inner surface 250a of the second support 250 may be parallel to the first surface 220a. For example, when the position of the second support 250 is the third position, a direction in which the inner surface 250a of the second support 250 faces may be the same as the direction in which the first surface 220a faces. According to an embodiment, when the position of the second support 250 is the third position, the second support 250 may be disposed in the through-hole 221. For example, when the position of the second support 250 is the third position, the inner surface 250a of the second support 250 may be disposed in the through-hole 221. According to an embodiment, when the position of the second support 250 is the fourth position, the second support 250 may be substantially perpendicular with respect to the first surface 220a and/or the second surface 220b. When the position of the second support 250 is the fourth position, the second support 250 may face the second side surface 120c of the second housing 120. For example, when the position of the second support 250 is the fourth position, the inner surface 250a of the second support 250 may face the second side surface 120c. When the position of the second support 250 is the fourth position, the second support 250 may protrude outside the through-hole 221. For example, when the position of the second support 250 is the fourth position, at least a portion of the second support 250 may be disposed outside the through-hole 221. For example, in the case that the second support 250 does not support the second housing 120, since the second base 220 has a planar shape, the electronic device 100 may slide with respect to the case 200 by self-load. In the case that the electronic device 100 slides with respect to the case 200, it may be difficult for the electronic device 100 to stably provide visual information to a user. The case 200 according to an embodiment may provide a structure capable of reducing a movement of the electronic device 100 in a state in which the case 200 is inclined with respect to the ground g1 by the second support 250 that supports the second side surface 120c of the second housing 120 in the fourth position.

According to an embodiment, a first base 210 may be further provided with a camera hole 212, that is, the camera hole 212 may be defined or formed through the first base 210. The camera hole 212 may pass through the first base 210. The camera hole 212 may correspond to (or overlap) a camera 150 of the electronic device 100 when the case 200 is coupled to the electronic device 100. The camera 150 may be configured to obtain an image based on receiving light from the outside of the electronic device 100. For example, a distance between the first base 210 and the ground g1 may be greater than a distance between the second base 220 and the ground g1 in a state in which the first support 240 supports the electronic device 100 to be inclined with respect to the ground g1. In the case that the camera hole 212 is disposed in the second base 220, since the ground g1 and the second base 220 are close to each other, a field of view (FoV) of the camera 150 of the electronic device 100 may be narrowed. In the case that the field of view of the camera 150 is narrowed, usability of the camera 150 may be reduced. Since the camera hole 212 is disposed in the first base 210, the case 200 according to an embodiment may provide a structure capable of improving the usability of the camera 150 of the electronic device 100 in the state in which the first support 240 supports the electronic device 100 to be inclined with respect to the ground g1. For example, since the camera hole 212 is disposed far from the ground g1 in the state in which the first support 240 supports the electronic device 100 to be inclined with respect to the ground g1, the field of view of the camera 150 of the electronic device 100 may be relatively enlarged.

As described above, the case 200 according to an embodiment may provide the structure capable of reducing the movement of the electronic device 100 with respect to the case 200 in the state in which the case 200 is inclined with respect to the ground g1, by the second support 250 capable of supporting the electronic device 100. Since the camera hole 212 is disposed in the first base 210 far from the ground g1, the case 200 according to an embodiment may provide a structure capable of enlarging the field of view of the camera 150 in the state in which the case 200 is inclined with respect to the ground g1.

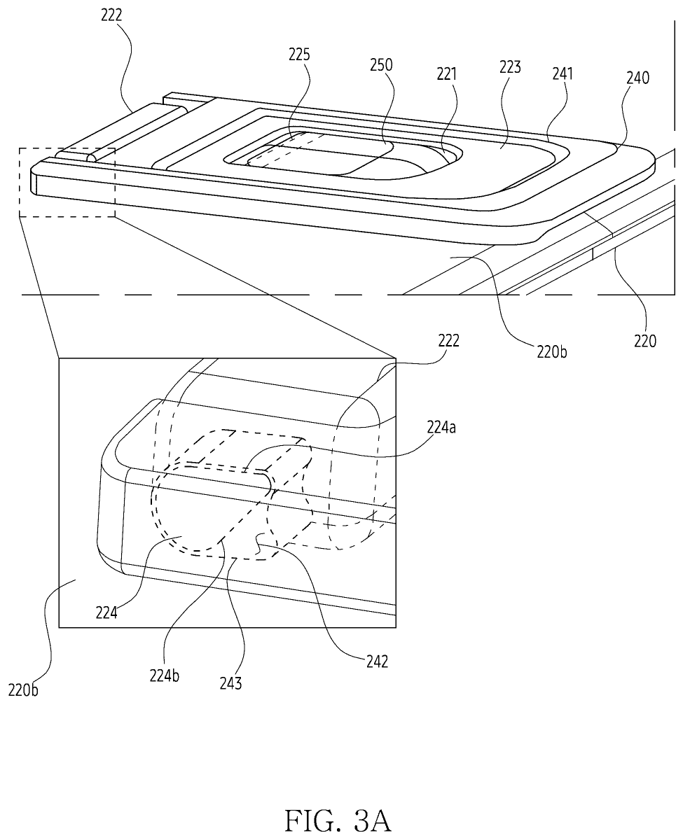

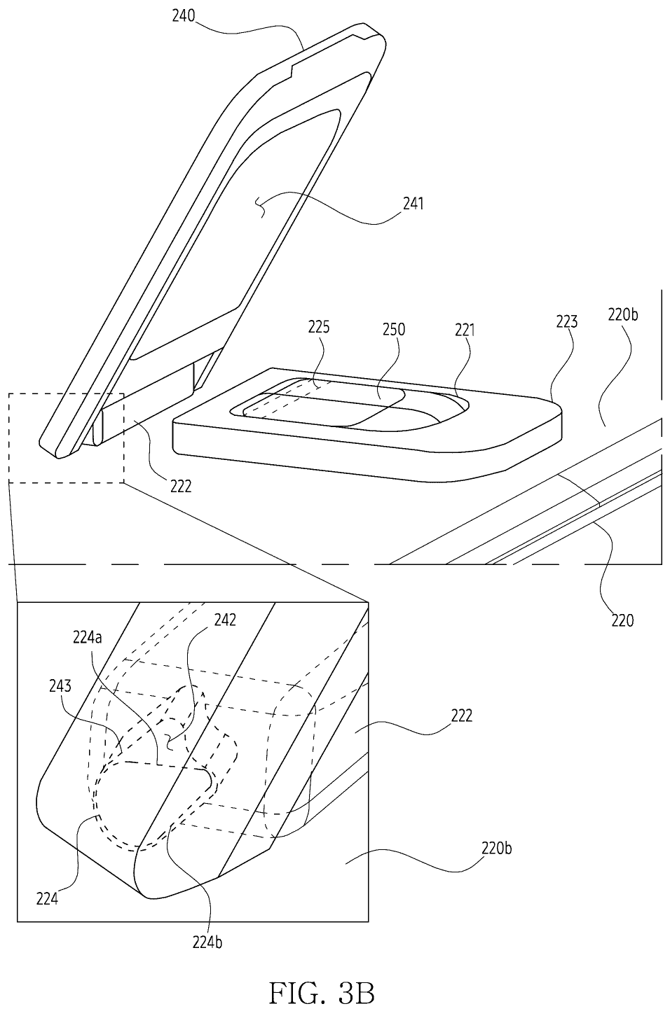

FIG. 3A illustrates a first support according to an embodiment in a first position, and FIG. 3B illustrates a first support according to an embodiment in a second position.

Referring to FIG. 3A and FIG. 3B, in an embodiment, a second base 220 may include a first protrusion 222, a second protrusion 223, a first shaft 224, and/or a second shaft 225.

The first protrusion 222 may be disposed on a second surface 220b of the second base 220. The first protrusion 222 may protrude from the second surface 220b of the second base 220. For example, the first protrusion 222 may extend from the second surface 220b along a direction in which the second surface 220b faces. According to an embodiment, the first protrusion 222 may be coupled to the first shaft 224. As the first shaft 224 is coupled to the first protrusion 222 protruding from the second surface 220b, when a first support 240 rotates with respect to the second surface 220b, interference between the first support 240 and the second surface 220b may be reduced.

The second protrusion 223 may be disposed on the second surface 220b of the second base 220. The second protrusion 223 may protrude from the second surface 220b of the second base 220. For example, the second protrusion 223 may extend from the second surface 220b along the direction in which the second surface 220b faces. According to an embodiment, the second protrusion 223 may be spaced apart from the first protrusion 222. The second protrusion 223 may surround a through-hole 221 in a plan view or when viewed in the direction in which the second surface 220b faces. The second protrusion 223 may enclose the through-hole 221. As the second protrusion 223 surrounds the through-hole 221, when a position of a second support 250 is a third position, the second protrusion 223 may surround the second support 250.

According to an embodiment, when a position of the first support 240 is a first position parallel to the second surface 220b, the second protrusion 223 may be surrounded by the first support 240. For example, the first support 240 may include an opening 241 passing through the first support 240. When the position of the first support 240 is the first position, the second protrusion 223 may be received in the opening 241. When the position of the first support 240 is the first position, the second protrusion 223 may be surrounded by the first support 240 in the opening 241. When the position of the first support 240 is a second position inclined with respect to the second surface 220b, the second protrusion 223 may be disposed outside the opening 241. The second protrusion 223 may not be surrounded by the first support 240.

The first shaft 224 may provide a rotation center (or a rotation axis) of the first support 240. The first support 240 may be coupled to the first shaft 224. For example, the first shaft 224 may pass through the first support 240. As the first support 240 is coupled to the first shaft 224, the first support 240 may be rotatable with respect to the second surface 220b based on the first shaft 224. According to an embodiment, the first shaft 224 may include a first cam surface 224a and a second cam surface 224b. The first cam surface 224a may be parallel to the second surface 220b of the second base 220. The second cam surface 224b may be connected to the first cam surface 224a. The second cam surface 224b may be inclined with respect to the first cam surface 224a.

According to an embodiment, the first support 240 may include a first pocket

242 and/or a first support surface 243. The first pocket 242 may provide or define a space in which the first support 240 is rotatable with respect to the second surface 220b. For example, the first pocket 242 may have a shape corresponding to a shape of the first shaft 224. According to an embodiment, the first pocket 242 may surround the first shaft 224. For example, the first pocket 242 may surround the first support surface 243 of the first support 240.

The first support surface 243 may define a rotation angle of the first support 240. For example, as the first support surface 243 contacts the first shaft 224, the rotation angle of the first support 240 may be defined. According to an embodiment, the first support surface 243 may have a shape corresponding to the first shaft 224. The first support surface 243 may surround the first shaft 224. At least a portion of the first support surface 243 may contact the first cam surface 224a of the first shaft 224 when the position of the first support 240 is the first position parallel to the second surface 220b. As the first support surface 243 contacts the first cam surface 224a parallel to the second surface 220b, the first support 240 may maintain a state parallel to the second surface 220b. The at least a portion of the first support surface 243 may be spaced apart from the second cam surface 224b of the first shaft 224 when the position of the first support 240 is the first position. The at least a portion of the first support surface 243 may contact the second cam surface 224b of the first shaft 224 when the position of the first support 240 is the second position inclined with respect to the second surface 220b. As the at least a portion of the first support surface 243 contacts with the second cam surface 224b inclined with respect to the second surface 220b, the first support 240 may maintain a state inclined with respect to the second surface 220b. The at least a portion of the first support surface 243 may be spaced apart from the first cam surface 224a of the first shaft 224 when the position of the first support 240 is the second position.

The second shaft 225 may provide a rotation center (a rotation axis) of the second support 250. The second support 250 may be coupled to the second shaft 225. For example, the second shaft 225 may pass through the second support 250. According to an embodiment, the second shaft 225 may pass through the second base 220. For example, the second shaft 225 may be disposed in the through-hole 221 of the second base 220.

As described above, the case 200 according to an embodiment may provide a structure capable of supporting an electronic device (e.g., the electronic device 100 of FIG. 1A and FIG. 1B) in an inclined state by the first shaft 224 defining the rotation angle of the first support 240.

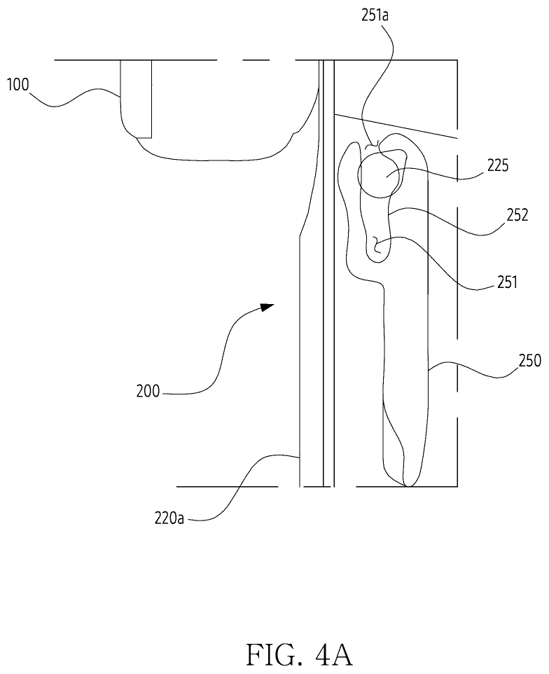

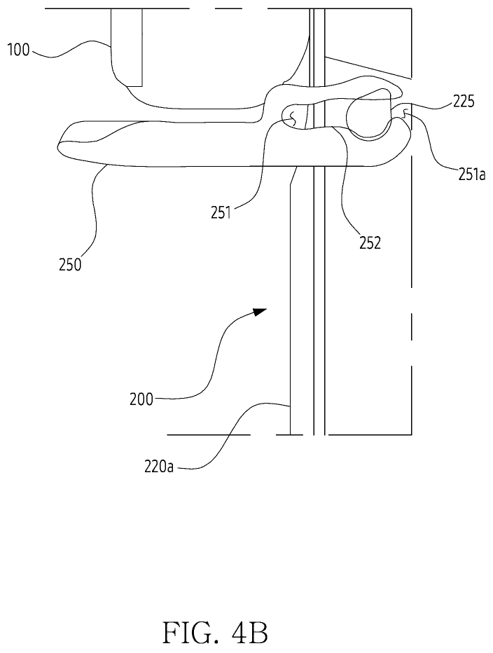

FIG. 4A illustrates a second support according to an embodiment in a third position, and FIG. 4B illustrates a second support according to an embodiment in a fourth position.

Referring to FIG. 4A and FIG. 4B, according to an embodiment, a second support 250 may include a second pocket 251 and/or a second support surface 252. The second pocket 251 may receive a second shaft 225. For example, the second pocket 251 may surround the second shaft 225. The second pocket 251 may have a shape corresponding to a shape of the second shaft 225. According to an embodiment, an end 251a of the second pocket 251 may be opened toward the outside of the second support 250. As the end 251a of the second pocket 251 is opened, the second support 250 may be coupled to the second shaft 225 through the end 251a of the second pocket 251.

The second support surface 252 may define a rotation angle of the second support 250. According to an embodiment, the second support surface 252 may surround the second pocket 251. For example, the second support surface 252 may have the shape corresponding to the shape of the second shaft 225. As the second support surface 252 has the shape corresponding to the shape of the second shaft 225, the second support surface 252 may contact at least a portion of the second shaft 225. For example, the second shaft 225 may be in close contact with the second support surface 252 by being fitted into the second pocket 251. A frictional force generated from the contact between the second support surface 252 and the second shaft 225 may maintain a position of the second support 250. When the position of the second support 250 is the third position parallel with respect to a first surface 220a, the frictional force generated from the contact between the second support surface 252 and the second shaft 225 may maintain the position of the second support 250. When the position of the second support 250 is the fourth position in which the second support 250 supports a second side surface 120c of a second housing 120, the frictional force generated from the contact between the second support surface 252 and the second shaft 225 may maintain the position of the second support 250. For example, a size of the frictional force generated between the second support surface 252 and the second shaft 225 when the position of the second support 250 is the fourth position may be greater than when the position of the second support 250 is the third position, so that the second support 250 may stably support an electronic device 100.

As described above, the case 200 according to an embodiment may provide a structure capable of supporting the electronic device 100 in a state in which the case 200 is inclined with respect to the ground (e.g., the ground g1 of FIG. 2B and/or FIG. 2C) by the second shaft 225 providing the rotation center of the second support 250.

A case may include a structure capable of supporting an electronic device in a state of being coupled to the electronic device. For example, the case may include a structure capable of supporting the electronic device in an inclined state with respect to the ground. A user of the electronic device may receive content (e.g., a video) through the electronic device in a state in which the electronic device is supported by the case. In a state in which the case is inclined with respect to the ground, the electronic device may move with respect to the case by self-load. In the case that the electronic device moves with respect to the case, the user may feel uncomfortable in a process of viewing the content through the electronic device. The case may be desired to have a structure capable of reducing a movement of the electronic device with respect to the case while supporting the electronic device in the state inclined with respect to the ground.

A case (e.g., the case 200 of FIG. 2A and FIG. 2B) detachably coupled to an electronic device (e.g., the electronic device 100 of FIG. 1A and FIG. 1B) according to an embodiment includes a first base (e.g., the first base 210 of FIG. 2A and FIG. 2B) coupled to a portion (e.g., the first housing 110 of FIG. 1A and FIG. 1B) of the electronic device. According to an embodiment, the case includes a second base (e.g., the second base 220 of FIG. 2A and FIG. 2B) coupled to the first base to be rotatable relative to the first base, where the second base includes a first surface (e.g., the first surface 220a of FIG. 2A and FIG. 2B) facing another portion (e.g., the second housing 120 of FIG. 1A and FIG. 1B) of the electronic device and a second surface (e.g., the second surface 220b of FIG. 2A and FIG. 2B) opposite to the first surface. According to an embodiment, the case includes a first support (e.g., the first support 240 of FIG. 2A and FIG. 2B) rotatably coupled to the second base, and movable to be parallel to the second surface by rotation in a first rotation direction or movable to be inclined with respect to the second surface by rotation in a second rotation direction opposite to the first rotation direction. According to an embodiment, the case includes a second support (e.g., the second support 250 of FIG. 2A and FIG. 2B) coupled to the second base to be rotatable independently of the first support, and movable to be parallel to the second surface by rotation in the second rotation direction, or movable to support a side surface (e.g., the second side surface 120c of FIG. 2A and FIG. 2B) of the electronic device disposed on the first surface by rotation in the first rotation direction. According to various embodiments, being movable may include a meaning of being rotatable. For example, a description as the first support (e.g., the first support 240 of FIG. 2A and FIG. 2B) movable to be inclined with respect to the second surface of the case (e.g., the case 200 of FIG. 2A and FIG. 2B) may include a meaning that the first support is rotatable with respect to the second surface of the case.

The case according to an embodiment may provide a structure capable of reducing a sliding of the electronic device with respect to the case in a state in which the case is inclined with respect to the ground by the second support capable of supporting the side surface of the electronic device.

According to an embodiment, the first base may be provided with a camera hole (e.g., the camera hole 212 of FIG. 2A and FIG. 2B) defined therethrough to correspond to a camera of the electronic device.

Since the camera hole is disposed in the first base far from the ground, in the state in which the case is inclined with respect to the ground, the case according to an embodiment may provide a structure capable of improving usability of the camera of the electronic device.

According to an embodiment, the first base may include a third surface (e.g., the third surface 210a of FIG. 2A and FIG. 2B) which supports the portion of the electronic device. According to an embodiment, a state of the case may be changeable to a first state in which directions in which the first surface and the third surface of the second base face are the same as each other, by rotation in the second rotation direction of the second base, and to a second state in which the first surface faces the third surface by rotation in the first rotation direction of the second base.

The case according to an embodiment may have a shape corresponding to a change in a shape of the electronic device by the first base and the second base that are rotatable with respect to each other.

According to an embodiment, the second base may include a first cam surface (e.g., the first cam surface 224a of FIG. 3A and FIG. 3B) parallel to the second surface, and a second cam surface (e.g., the second cam surface 224b of FIG. 3A and FIG. 3B) inclined with respect to the first cam surface and connected to the first cam surface, and a first shaft (e.g., the first shaft 224 of FIG. 3A and FIG. 3B) disposed through the first support. According to an embodiment, the first support may include a support surface (e.g., the first support surface 243 of FIG. 3A and FIG. 3B) that has a shape corresponding to the first shaft to surround the first shaft, the support surface contacting the first cam surface when the first support is in a position parallel to the second surface and contacting the second cam surface when the first support is in an inclined position relative to the second surface.

The case according to an embodiment may provide a structure capable of supporting the electronic device in an inclined state with respect to the ground by the first cam surface and a second cam surface for defining a rotation angle of the first shaft.

According to an embodiment, the second base may include a first protrusion (e.g., the first protrusion 222 of FIG. 3A and FIG. 3B) coupled to the first shaft and protruding from the second surface.

Since the first shaft is coupled to the first protrusion protruding from the second surface, the case according to an embodiment may provide a structure in which interference of the first support and the second base is reduced. According to an embodiment, the first support may include a first pocket (e.g.,

the first pocket 242 of FIG. 3A and FIG. 3B) surrounded by the support surface and configured to provide a space for movement of the first shaft.

The case according to an embodiment may provide a structure in which the first support is movable with respect to the second base by the first pocket providing the space for the movement of the first support.

According to an embodiment, the first support may be provided with an opening (e.g., the opening 241 of FIG. 3A and FIG. 3B) defined therethrough. According to an embodiment, the second support may be surrounded by the first support within the opening in a position parallel to the second surface.

The case according to an embodiment may provide a structure capable of reducing a size of the case by the opening of the first support receiving the second support.

According to an embodiment, the second base may include a second protrusion (e.g., the second protrusion 223 of FIG. 3A and FIG. 3B) protruding from the second surface and surrounding the second support. According to an embodiment, the first support may surround the second protrusion in a position parallel to the second surface.

The case according to an embodiment may provide a structure capable of reducing the size of the case by the first support surrounding the second protrusion.

According to an embodiment, the second base may be provided with a through-hole (e.g., the through-hole 221 of FIG. 2A and FIG. 2B) defined therethrough to receive the second support.

The case according to an embodiment may provide a structure capable of reducing the size of the case through the through-hole receiving the second support.

According to an embodiment, the second base may include a second shaft (e.g., the second shaft 225 of FIG. 4A and FIG. 4B) disposed through the second support.

According to an embodiment, the second support may include a second pocket (e.g., the second pocket 251 of FIG. 4A and FIG. 4B) having a shape corresponding to a shape of the second shaft and surrounding the second shaft.

The case according to an embodiment may provide a structure capable of supporting the side surface of the electronic device by the second support rotatable with respect to the second shaft.

According to an embodiment, an end (e.g., the end 251a of FIG. 4A and FIG. 4B) of the second pocket may be opened toward the outside of the second support.

The case according to an embodiment may provide a structure in which the second support may be assembled through the second pocket opened toward the outside of the second support.

According to an embodiment, the case may include a connecting plate (e.g., the connecting plate 230 of FIG. 1A and FIG. 1B) connected between the first base and the second base.

The case according to an embodiment may provide a structure in which the first base and the second base are rotatable with respect to each other by the connecting plate connecting the first base and the second base.

According to an embodiment, the second base may have a shape extending in a direction parallel to the second surface such that an area of the side surface of the electronic device is exposed outside the case.

Since the second base has a substantially planar shape, the case according to an embodiment may provide a structure capable of reducing damage to the connecting plate due to stress generated according to a change in the state of the electronic device.

According to an embodiment, the first base may include a third surface which supports the portion of the electronic device. According to an embodiment, the first base may include a sidewall (e.g., the sidewall 211 of FIG. 1A and FIG. 1B) disposed on a periphery of the third surface to surround an area of the side surface of the electronic device.

The case according to an embodiment may provide a structure capable of maintaining a state coupled with the electronic device by the sidewall surrounding the side surface of the electronic device.

According to an embodiment, the second support may be perpendicular to the first surface in a position supporting the side surface of the electronic device.

The case according to an embodiment may provide a structure capable of supporting the side surface of the electronic device by the second support protruding on the first surface.

A case (e.g., the case 200 of FIG. 2A and FIG. 2B) detachably coupled to an electronic device (e.g., the electronic device 100 of FIG. 1A and FIG. 1B) according to an embodiment includes a first base (e.g., the first base 210 of FIG. 2A and FIG. 2B) coupled to a portion (e.g., the first housing 110 of FIG. 1A and FIG. 1B) of the electronic device. According to an embodiment, the case includes a second base (e.g., the second base 220 of FIG. 2A and FIG. 2B) coupled to the first base to be rotatable relative to the first base, where the second base includes a first surface (e.g., the first surface 220a of FIG. 2A and FIG. 2B) facing another portion (e.g., the second housing 120 of FIG. 1A and FIG. 1B) of the electronic device, a second surface (e.g., the second surface 220b of FIG. 2A and FIG. 2B) opposite to the first surface, and a through-hole (e.g., the through-hole 221 of FIG. 2A and FIG. 2B) is defined through the second based to extend from the first surface to the second surface. According to an embodiment, the case includes a first support (e.g., the first support 240 of FIG. 2A and FIG. 2B), rotatably coupled to the second base, and movable to be parallel to the second surface by rotation in a first rotation direction or movable to be inclined with respect to the second surface by rotation in a second rotation direction opposite to the first rotation direction. According to an embodiment, the case includes a second support (e.g., the second support 250 of FIG. 2A and FIG. 2B), coupled to the second base to be rotatable independently of the first support, and movable to be received within the through-hole by rotation in the second rotation direction or movable to support a side surface (e.g., the second side surface 120c of FIG. 2A and FIG. 2B) of the electronic device disposed outside the through-hole by rotation in the first rotation direction.

The case according to an embodiment may provide a structure capable of reducing a sliding of the electronic device with respect to the case in a state in which the case is inclined with respect to the ground by the second support capable of supporting the side surface of the electronic device.

According to an embodiment, the first base may be provided with a camera hole (e.g., the camera hole 212 of FIG. 2A and FIG. 2B) defined therethrough to correspond to a camera of the electronic device.

Since the camera hole is disposed in the first base far from the ground, the case according to an embodiment may provide a structure capable of improving usability of the camera of the electronic device in the state in which the case is inclined with respect to the ground.

According to an embodiment, the first base may include a third surface (e.g., the third surface 210a of FIG. 2A and FIG. 2B) which supports the portion of the electronic device. According to an embodiment, a state of the case may be changeable to a first state in which directions in which the first surface and the third surface of the second base face are the same as each other, by rotation in the second rotation direction of the second base, and to a second state in which the first surface faces the third surface by rotation in the first rotation direction of the second base.

The case according to an embodiment may have a shape corresponding to a change in a shape of the electronic device by the first base and the second base that are rotatable with respect to each other.

According to an embodiment, the second base may include a second shaft (e.g., the second shaft 225 of FIG. 4A and FIG. 4B) disposed through the second support.

According to an embodiment, the second support may include a second pocket (e.g., the second pocket 251 of FIG. 4A and FIG. 4B) having a shape corresponding to a shape of the second shaft and surrounding the second shaft.

The case according to an embodiment may provide a structure capable of supporting the electronic device in an inclined state with respect to the ground by a first cam surface and a second cam surface for defining a rotation angle of the first shaft.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one selected from A and B,” “at least one of A or B,” “A, B, or C,” “at least one of A, B, and C,” at least one selected from A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It will be understood that when an element is referred to as being “on” another element, it can be directly on the other element or intervening elements may be present therebetween. In contrast, when an element is referred to as being “directly on” another element, there are no intervening elements present. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration.

What is claimed is:

1. A case detachably coupled to an electronic device, the case comprising:
a first base coupled to the electronic device;
a second base coupled to the first base to be rotatable relative to the first base, wherein the second base includes a first surface which supports the electronic device and a second surface opposite to the first surface;
a first support rotatably coupled to the second base, and movable to be parallel to the second surface by rotation in a first rotation direction or movable to be inclined with respect to the second surface by rotation in a second rotation direction opposite to the first rotation direction; and
a second support rotatably coupled to the second base, and movable to be parallel to the second surface by rotation in the second rotation direction or movable to support a side surface of the electronic device disposed on the first surface by rotation in the first rotation direction.

2. The case of claim 1,
wherein a camera hole is defined through the first base to correspond to a camera of the electronic device.

3. The case of claim 1,
wherein the first base includes a third surface which supports a portion of the electronic device, and
wherein a state of the case is changeable to a first state in which directions in which the first surface and the third surface of the second base face are the same as each other, by rotation in the second rotation direction of the second base, and to a second state in which the first surface faces the third surface by rotation in the first rotation direction of the second base.

4. The case of claim 1,
wherein the second base includes a first cam surface parallel to the second surface, and a second cam surface inclined with respect to the first cam surface and connected to the first cam surface, and a first shaft disposed through the first support, and
wherein the first support includes a support surface that surrounds the first shaft in a shape corresponding to the first shaft, the support surface contacting the first cam surface when the first support is in a position parallel to the second surface and contacting the second cam surface when the first support is in an inclined position relative to the second surface.

5. The case of claim 4,
wherein the second base further includes a first protrusion coupled to the first shaft and protruding from the second surface.

6. The case of claim 4,
wherein the first support further includes a first pocket surrounded by the support surface and configured to provide a space for movement of the first shaft.

7. The case of claim 1,
wherein an opening is defined through the first support, and
wherein the second support is surrounded by the first support within the opening in a position parallel to the second surface.

8. The case of claim 1,
wherein the second base further includes a second protrusion protruding from the second surface and surrounding the second support, and
wherein the first support surrounds the second protrusion in a position parallel to the second surface.

9. The case of claim 1,
wherein a through-hole is defined through the second base, and the second support is disposed in the through-hole.

10. The case of claim 1,
wherein the second base further includes a second shaft disposed through the second support, and
wherein the second support includes a second pocket having a shape corresponding to a shape of the second shaft and surrounding the second shaft.

11. The case of claim 10,
wherein an end of the second pocket is opened toward an outside of the second support.

12. The case of claim 1,
further including a connecting plate connected between the first base and the second base.

13. The case of claim 1,
wherein the second base has a shape extending in a direction parallel to the second surface such that an area of the side surface of the electronic device is exposed outside the case.

14. The case of claim 1,
wherein the first base includes:
a third surface which supports a portion of the electronic device; and
a sidewall disposed on a periphery of the third surface to surround an area of the side surface of the electronic device.

15. The case of claim 1,
wherein the second support is perpendicular to the first surface in a position in which the second support supports the side surface of the electronic device.

16. A case detachably coupled to an electronic device the case comprising:
a first base coupled to a portion of the electronic device;
a second base coupled to the first base to be rotatable relative to the first base, wherein the second base includes a first surface which supports another portion of the electronic device and a second surface opposite to the first surface, and a through-hole is defined through the second based to extend from the first surface to the second surface;
a first support rotatably coupled to the second base, and movable to be parallel to the second surface by rotation in a first rotation direction or movable to be incline with respect to the second surface by rotation in a second rotation direction opposite to the first rotation direction; and
a second support coupled to the second base to be rotatable independently of the first support, and movable to be received within the through-hole by rotation in the second rotation direction or movable to support a side surface of the electronic device disposed outside the through-hole by rotation in the first rotation direction.

17. The case of claim 16,
wherein a camera hole is defined through the first base, to correspond to a camera of the electronic device.

18. The case of claim 16,
wherein the first base includes:
a third surface which supports the portion of the electronic device; and
a fourth surface opposite to the third surface, and
wherein a state of the second base is changeable to a first state in which the first surface faces the third surface by rotation in the first rotation direction of the second base and to a second state in which directions in which the first surface and the third surface of the second base face are the same as each other, by rotation in the second rotation direction of the second base.

19. The case of claim 16,
wherein the second base includes a first cam surface parallel to the second surface and a second cam surface inclined with respect to the first cam surface and connected to the first cam surface, and a first shaft disposed through the first support, and
wherein the first support includes a support surface having a shape corresponding to the first shaft to surround the first shaft, and the support surface contacts the first cam surface in a state in which the first support is parallel to the second surface and contacting the second cam surface in a state in which the first support is inclined to the second surface.

20. The case of claim 16,
wherein the second base further includes a second shaft disposed within the through-hole and passing through the second support, and
wherein the second support includes a second pocket having a shape corresponding to a shape of the second shaft and surrounding the second shaft.
